(19) United States
(12) Patent Application Publication
(10) Pub. No.: US 2004/0207276 A1
(43) Pub. Date: Oct. 21, 2004

(54) Clutched starter motor assembly for aircraft piston

(76) Inventors: Eugene Chiappe, Granbury, TX (US); Leven Edward Staples, Granbury, TX (US)

Correspondence Address: Leven E. Staples, 9641 Airpark Drive, Granbury, TX, 76049, US

(21) Appl. No.: 10/418,913

(22) Filed: Apr. 21, 2003

(51) Int. Cl. H02K 7/10

(52) U.S. Cl. 310/78

(57) ABSTRACT

A Starter Motor Assembly for a piston aircraft engine is constructed by placing a clutch mechanism between the armature of a DC motor and a gear-reduction assembly. The output of said gear-reduction assembly is an output shaft that engages with the starter adapter of the engine. Such construction provides low resistance to rotation of the output shaft by the engine's starter adapter to reduce potential wear and allows the use of a smaller and lighter motor than would be possible without the gear-reduction. In addition, the choice of a centrifugal clutch in the preferred embodiment prevents the motor from being damaged by overheating in a stalled (non rotation) condition as the clutch disengages below a chosen motor rotation speed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to starter motors (cranking motors) for piston aircraft engines that are equipped with wrap-spring clutch type starter adapters. Examples of these include all of the horizontally opposed engines manufactured by Teledyne Continental Motors that have displacements in excess of 300 cubic inches. The original equipment starter motors were simple series-wound DC motors that drove the engine's starter adapter with no intervening gearing. In order to provide sufficient torque to turn the engine without gearing in the starter motor assembly, a large diameter armature was required with a corresponding large and heavy field housing.

Geared cranking motors could provide sufficient torque in a much smaller and lighter form. The design of many of the starter adapters, however, required a very low resistance to rotation of the starter motor when not cranking so that the motor could be rotated in the opposite direction from the cranking direction by the force of a compressed spring in the adapter to fully release the wrap-spring clutch in the adapter. If the adapter is unable to rotate the starter motor in the reverse direction to release the wrap-spring clutch, adapter components wear prematurely. Geared motor assemblies, especially those with a permanent-magnet field, typically present too much resistance to rotation to be overcome by the compressed spring in the adapter.

### BRIEF SUMMARY OF THE INVENTION

The invention is a starter motor assembly for piston aircraft engines which are equipped with wrap-spring clutch-type starter adapters. The invention contains a DC motor and gear-reduction output assembly as well as a clutching mechanism within the assembly which disengages the motor section from the output shaft so as to provide very low mechanical resistance to rotation of the output shaft when power is not applied to the motor. As a result of the clutching mechanism in the starter motor assembly, the output shaft and the starter adapter's shaft are free to rotate in either direction when power is not applied to the motor, greatly reducing premature wear of the engine/starter adapter. The use of gear-reduction is integral to this invention as it enables the unit to increase cranking torque with lower current requirements and lower weight than original equipment starter units.

### BRIEF DESCRIPTION OF THE DRAWINGS

FIG. 1 is a scale drawing of the starter motor assembly that is the subject of this patent and, to the same scale, an original equipment starter (Teledyne Continental Motors Model 627842) with the two outlines superimposed.

FIG. 2 is a section-views of the Starter Motor Assembly that is the subject of this patent with the major components identified.

### DETAILED DISCRIPTION OF THE INVENTION

Starter Fit:

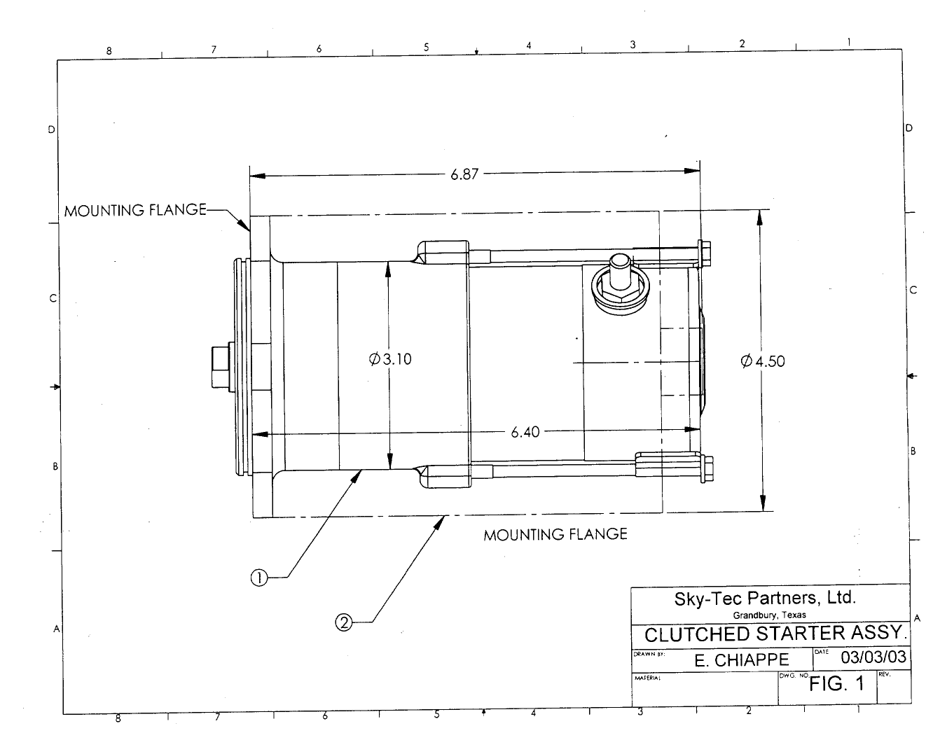

As can be seen from FIG. 1, the Starter Motor Assembly that is the subject of this invention (1) fits within the outline of the original equipment starter (2) and mounts in the same manner to the engine's starter adapter. This allows the starter motor assembly that is the subject of this invention to be substituted in any application that used the original equipment starter shown.

Construction:

The Starter Motor Assembly shown in FIG. 2 is comprised of a two-piece housing; the Engine Adapter (1) and the Motor Adapter (2). A Planetary Gear-Reduction Assembly (3) is housed in the Engine Adapter (1). A Centrifugal Clutch (4) is housed in the Motor Adapter (2). A DC motor (5) is joined to the Motor Adapter (2) by bolts. The Motor Adapter (2) is attached to the Engine Adapter (1) by bolts.

Operation:

When electric power is applied to the Motor Power Terminal (6), the Motor turns. When sufficient rotational speed is reached, the Centrifugal Clutch (4) engages and drives the input of the Planetary Gear Reduction Assembly (3). The output of the Planetary Gear Reduction Assembly (3) is the Output Shaft (7) which is engaged with the engine's starter adapter and cranks (rotates) the engine.

When power is removed from the Motor Power Terminal (6), the Motor ceases to turn and the Centrifugal Clutch (4) disengages. The only resistance to rotation of the Output Shaft (7) by the starter adapter with which it is engaged is the friction within the Planetary Gear Reduction Assembly (3) and any residual resistance of the Centrifugal Clutch (4). These components are designed in such a manner that this resistance is less than that of the original equipment starter motors.

We claim:

1. A Starter Motor Assembly for aircraft piston engines equipped with wrap-spring clutch type starter adapters, said Starter Motor Assembly incorporating a DC motor, gear-reduction mechanism, and a clutch mechanism which acts to mechanically disengage said DC motor from the gear-reduction mechanism when said motor is not powered.

2. The Starter Motor Assembly of claim 1 in which said DC motor is of the permanent-magnet field type.

3. The Starter Motor Assembly of claim 1 in which said DC motor is of the wound-field type.

4. The Starter Motor Assembly of claim 1 in which the gear-reduction is of the planetary type.

5. The Starter Motor Assembly of claim 1 in which the clutch mechanism is of the centrifugal-engagement type.

6. The Starter Motor Assembly of claim 2 in which the gear-reduction mechanism is of the planetary type.

7. The Starter Motor Assembly of claim 2 in which the clutch mechanism is of the centrifugal-engagement type.

8. The Starter Motor Assembly of claim 3 in which the gear-reduction mechanism is of the planetary type.

9. The Starter Motor Assembly of claim 3 in which the clutch mechanism is of the centrifugal engagement type.
